(19) United States
(12) Patent Application Publication
(10) Pub. No.: US 2017/0137310 A1
(43) Pub. Date: May 18, 2017

(54) PURIFYING DEVICE AND METHOD FOR ELIMINATION OF XENOBIOTICS IN WATER

(71) Applicant: DERICHEBOURG AQUA, VILLENEUVE LA GARENNE (FR)

(72) Inventors: Esther Oliveros, Cepet (FR); Andre Braun, Cepet (FR); Marie-Therese Maurette, Toulouse (FR); Florence Benoit-Marquie, Buzet sur Tarn (FR); Jacques Debuire, Montastruc la Conseillere (FR)

(73) Assignee: DERICHEBOURG AQUA, VILLENEUVE LA GARENNE (FR)

(21) Appl. No.: 15/336,164

(22) Filed: Oct. 27, 2016

Related U.S. Application Data
(62) Division of application No. 13/318,303, filed on Dec. 12, 2011, now abandoned.
Application No. 13/318,303 is a continuation-in-part of application No. PCT/FR2009/050800, filed on Apr. 30, 2009.

(51) Int. Cl. C02F 9/00; C02F 1/467; C02F 1/74; C02F 1/72; C02F 1/32; C02F 1/44

(52) U.S. Cl. CPC C02F 9/00; C02F 1/325; C02F 1/444; C02F 1/74; C02F 1/727; C02F 1/4672; C02F 2103/343

(57) ABSTRACT

A purifying method for photochemical elimination of xenobiotics present in water. The purifying device is used which has a photochemical reactor unit having at least one inlet for contaminated water and one outlet for purified water, it provides a flow path for continuously flowing water from said inlet to said outlet, and is equipped with a radiation source module providing ultraviolet radiation in a wavelength range ranging from 100 to 280 nm. The method includes performing ultrafiltration, thereby removing suspended and solvated macromolecular matter from the water; conducting the permeate via the at least one inlet into the photochemical reactor unit; subjecting the water flowing from said inlet to said outlet to ultraviolet radiation at wavelengths ranging from 100 to 280 nm, thereby generating hydroxyl radicals initiating degradation of said xenobiotics; and supplying air or dioxygen into the water, thereby enhancing the initiated oxidative degradation of said xenobiotics.

### CROSS-REFERENCE TO RELATED APPLICATIONS

This application is a division of U.S. application Ser. No. 13/318,303 filed Dec. 12, 2011, which is the U.S. national phase of PCT Appin. No. PCT/M2010/000982 filed Apr. 30, 2010 which claims priority to PCT Appin. No. PCT/FR2009/050800 application filed Apr. 30, 2009 the disclosures of which are incorporated in their entirety by reference herein.

The present invention refers to the field of water treatment, especially to a device and a method for the elimination of chemically and biologically active compounds, summarized as xenobiotics.

Decontamination of water is one of the most important issues on earth. A large number of technologies has been developed in order to decompose, alter or remove chemical compounds. So, WO/1999/055622 discloses an apparatus and a method for removing strong oxidizing agents from liquids, the apparatus consisting of an irradiation unit and followed by a treatment unit that may be a softener unit, a reaction vessel with a metal redox medium or combinations thereof In the irradiation unit, UV light in the wavelength range of 185-254 nm is used.

In EP 1 160 203, a method and a device for degradation of organic compounds in aqueous solution by photolysis of water with vacuum UV radiation in a range between 120 and 210 nm and by electrochemical production of dioxygen are described, the latter taking place in the irradiated part of the solution.

US 2006/0124556 A1, too, discloses an apparatus and a method for liquid purification. The apparatus comprises a plurality of filtration units, arranged in series with laser photolytic chambers producing light in the 100 to 300 nm range. Said multistep apparatus and method are designed to kill microbes and aromatic ring structures; it seems to be designed for end user applications.

Further, Sosnin et al. describe in “Application of capacitive and barrier discharge excimer lamps in photoscience”, Journal of Photochem. and Photobiol. C: Photochem. Rev., 7, 2006, p. 145-163, the use of ultraviolet and vacuum ultraviolet radiation produced by excimer lamps for oxidation and mineralization of organic substrates in aqueous phase. An apparatus in bench-scale is disclosed with a flow-through photochemical reactor with water recirculating between a reservoir and the photoreactor.

Considering the state in the art, there is still a need for providing reliable means to purify water contaminated with xenobiotics on industrial scale.

Further embodiments of the device and the method according to this invention are disclosed in the dependent claims.

The present invention seeks to provide a device and method to eliminate xenobiotics from water, in particular from waste water and in processing of potable water. “Xenobiotics” means xenobiotic pollutants in concentrations of micro- to femtogram per liter, in particular those resulting from manufacturing and consumption of pharmaceuticals as well as those resulting from any other sources of xenobiotics production and use.

In a first embodiment of the present invention, a purifying device for photochemical elimination of xenobiotics is provided. The device can be used for up to industrial scale applications.

The purifying device comprises a photochemical reactor unit having one or more inlets for xenobiotics contaminated water and one or more outlets for purified water with a flow path for continuously flowing water being provided from the inlet to said outlet. The reactor unit is equipped with a radiation source module that produces ultraviolet radiation in the 100 to 280 nm wavelength range. Further, the purifying device comprises one or more membrane filtration units being connected upstream of said photochemical reactor unit. The membrane filtration is designed to perform ultra filtration, thereby advantageously collecting particulate matter and solvated macromolecules contained in the water stream subjected to subsequent photochemical treatment. Removing said particulate and macromolecular matter from the water stream leads to a higher transparency of the water and increases the efficiency of pollutant degradation.

In order to advantageously assist the process of oxidative degradation and to achieve total mineralization of the xenobiotics, the purifying device is additionally equipped with at least one device for supplying dioxygen, preferably air, into the photochemical reactor unit. Generally, the purified compressed air or dioxygen will be provided in a compressed manner. But dioxygen may also be produced in situ by electrolysis.

The purifying device may further comprise a water level regulating system or a water flow-through regulating system, said system preferably being combined with an intermediate reservoir balancing differing flow-through rates of water being treated between the photochemical reactor and the membrane filtration units.

The radiation source module is connected to an electrical power supply that may also be used for operating and controlling the electrical input and the radiation output of the module.

To perform ultra filtration, the membrane filtration unit comprised of an embodiment of the purifying device according to the present invention has a membrane with pore sizes in a range from 0.07 to 0.25 μm with an average pore size of 0.12 μm. The membrane filtration unit is installed to perform either cross-flow filtration or dead-end filtration—both well known to the person skilled in the art—the permeate passing the filter being led into the photochemical reactor unit. Preferably the membrane of the purifying device is a hydrophilic membrane corresponding to the chemical characteristics of the medium to be filtered.

Other embodiments of the present invention refer to the radiation source module used within the photochemical reactor and arranged in a parallel or in a transverse direction in relation to the water flow path, or the water flow, respectively, provided between the inlet and outlet.

The radiation source module may comprise at least one enveloping tube surrounding a radiation source which enveloping tube is at least partially transparent for the emitted ultraviolet radiation. Preferably, the material of the enveloping tube is synthetic quartz that is robust, thermally resistant, chemically inert and transparent also in the wavelength range below 200 nm.

Further, the purifying device according to an embodiment of the present invention may comprise cleaning means to perform mechanical and/or chemical cleaning of the radiation source module, in particular of the enveloping tube in order to prevent loss of radiation efficiency. The cleaning method can be conducted manually or it can be triggered automatically, following a preset timing or a signal originating from transparency measurements.

Depending on a volume flow of the waste water and depending on the photochemical reactor unit design, a plurality of radiation source modules may be operated in series and/or in parallel within said photochemical reactor unit. Generally, the types of radiation source modules are selected according to the desired emission spectra emitting light with wavelengths in the range from 100 to 280 nm. Appropriate ultraviolet radiation sources are mercury low pressure lamps, emitting ultraviolet radiation predominantly at wavelengths of 185 nm and 254 nm.

In order to treat a large quantity of contaminated water, the purifying device may comprise a plurality of photochemical reactor units and, respectively, a suitable number of membrane filtration units which can be arranged in series or in parallel or both, depending on the characteristics of the water to be treated and/or on the flow conditions. Generally, a membrane filtration unit is installed upstream of each photochemical reactor unit.

Further, the purifying device may comprise at least one device for feeding hydrogen peroxide into the photochemical reactor unit to improve the degradation of xenobiotics: Adding hydrogen peroxide during the irradiation stage leads to enhanced generating of hydroxyl radicals in particular at wavelengths above 190 nm, whereas in the wavelength range from 100 to 190 nm, hydroxyl radicals are generated by photolysis and/or homolysis of water molecules. The hydroxyl radicals initiate different radical reactions with the xenobiotics, which, in combination with said provided dioxygen (in air or pure) lead to the oxidative degradation and eventual mineralization of the xenobiotics.

The xenobiotics that are treated and eliminated with the device according to an embodiment of the invention and by use of the herein described methods are exogenous molecules with relative low molecular masses; these xenobiotics may result from drug compositions, or may be comprised in water or air pollutants or food additives, phytopharmaceuticals, and other sources.

The method for eliminating xenobiotics in water according to an embodiment of the invention uses a purifying device as described above. The method is a simple procedure which generally requires performing two steps only: filtering the water and subjecting the permeate to irradiation at the desired wavelength(s).

First, a continuous flow of contaminated water is fed into the membrane filtration unit to carry out said ultra filtration step, thereby removing suspended and solvated macromolecular matter from the water. Then, the pre-purified water—the “permeate”—is led into the photochemical reactor unit, being subjected to ultraviolet radiation at wavelengths ranging from 100 to 280 nm, said xenobiotics being degraded due to photoinduced hydroxyl radical production. In the presence of air or dioxygen to be provided, the oxidative degradation may lead to the mineralization of said xenobiotics.

A continuous flow of purified water can be discharged now from the purifying device.

The method according to the invention comprising feeding contaminated water, filtering and irradiating filtered water for eliminating xenobiotics through oxidative methods and subsequently discharging the irradiated water may preferably be carried out as a continuous process. For such a purpose, several photochemical reactor units may be used in parallel or in series. Batch wise or semi-continuous processes are possible, but require that a continuous water flow is repeatedly subjected to ultraviolet radiation by recirculating it through one or several photochemical reactor unit(s).

The invention and the objects of the present invention will be better understood by reading the detailed description along with a number of examples and by reviewing the figures in which:

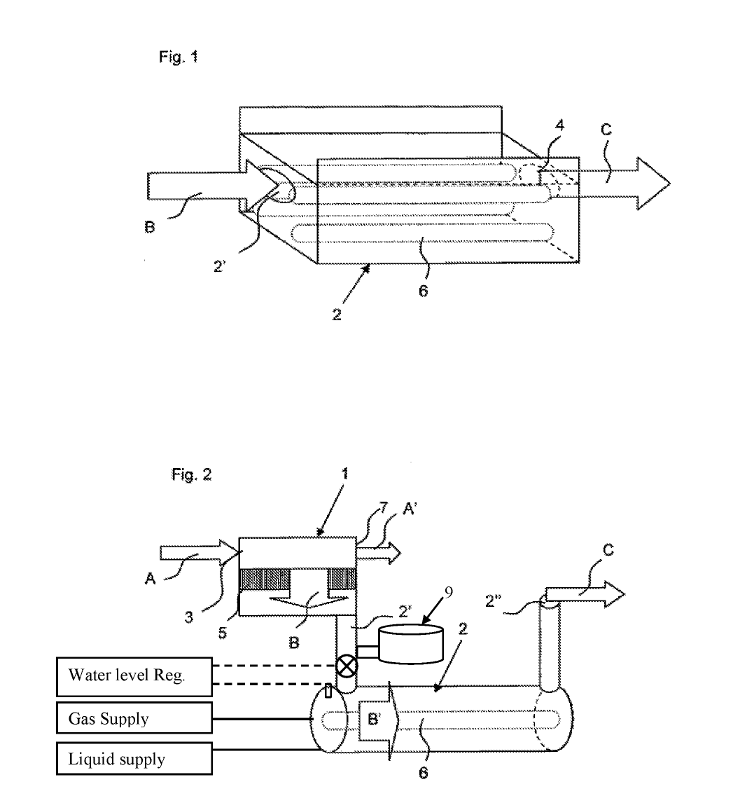

FIG. 1: shows a schematic illustration of a photochemical reactor unit with an open channel design, and

FIG. 2: shows a schematic illustration of a purifying device according to an embodiment of the invention with a cross-flow membrane filtration unit and a photochemical reactor unit.

FIGS. 1 and 2 show different types of the photochemical reactor unit 2 adapted to be incorporated in a purifying device of the present invention. Upstream to the photochemical reactor unit 2, the purifying device for photochemical elimination of xenobiotics in water is connected to a membrane filtration unit 1 shown in FIG. 2. The apparatus according to embodiments of the invention is suitable for large-scale waste water treatment or for processing potable water.

The membrane filtration unit shown in FIG. 2 has an inlet 3 for contaminated water inflow, indicated by arrow A. The suspended particulate or solvated macromolecular matter is concentrated or enriched in a retentate flow A′ flowing along the membrane 5 of the membrane filtration unit 1 which herein is a hydrophilic membrane having a pore size in a range from 0.07 to 0.25 μm with an average pore size of 0.12 μm. Since a typical microfiltration membrane pore size range is 0.1 to 10 μm and typical pore sizes of ultra filtration membranes are below 0.1 μm, the membrane 5 used in the device of the invention shows pore sizes in between micro- and ultra filtration. Cross flow filtration as shown in FIG. 2 prevents the membrane from fouling in that no filter cake is building up.

Depending on the flow conditions, a plurality of inlets into the membrane filtration unit can be provided.

Generally, microfiltration is a filtration method for removing contaminants from a fluid passing through a microporous membrane acting as micron sized filter. Microfiltration can be carried out using pressure or not. The filter membranes are porous and allow passage of water, monovalent species, dissolved organic matter, small colloids and viruses but they retain particles, sediment, algae or large bacteria. Employing ultrafiltration in waste water treatment serves additionally to separate, and concentrate target macromolecules in continuous filtration processes. Depending on the Molecular Weight Cut Off (MWCO) of the membrane used, macromolecules may be transferred into the permeate or separated and concentrated in the retentate.

In FIG. 2, the membrane 5 is arranged in a parallel direction relative to the fluid path from the inlet 3 to the outlet 7 of the retentate A′, providing cross-flow filtration. Cross-flow prevents fouling on the membrane 5. Separated suspended and solvated macromolecular matters are concentrated in the retentate A′ (see the arrow), whereas the permeate, indicated by arrow B1 charged with dissolved contaminants is fed via inlet 2′ into the photochemical reactor unit 2.

Build-up of filter cakes on the membrane might nevertheless occur when dead-end filtration is performed and requires periodical removal resulting in a discontinuous operation of the membrane filtration unit. It may therefore be advantageous to provide at least two membrane filtration units alternately connected to a waste water inlet and to the downstream photochemical reactor unit to make sure that water flows continuously through one of the membrane filtration units while the other one is subjected to maintenance.

The photochemical reactor unit 2 of the purifying device can be equipped with one radiation source module 6 as indicated by the dashed line in FIG. 2. Alternatively, it may be equipped with more than one radiation source modules 6 as illustrated in FIG. 1, wherein four radiation source modules 6 (dashed lines) are arranged parallel to each other and aligned with the main flow path B′ within the reactor, which is connected with the permeate B outlet of the membrane filtration unit 1. Each radiation source module 6 includes a radiation source which emits ultraviolet radiation in the 100 to 280 nm wavelength range.

The radiation source modules 6 within the photochemical reactor unit 2 in FIGS. 1 and 2 are aligned the water flow path B′. Other photochemical reactor units may contain radiation source modules positioned vertically to the main flow path provided. In case more than one radiation source module is used within the photochemical reactor, the modules may be arranged unidirectional, in parallel or transverse, or they may be arranged forming a cross-pattern to achieve homogeneous illumination of the irradiated reactor volume.

The radiation source of a radiation source module may be surrounded by at least one enveloping tube. This enveloping tube is at least partially transparent for radiation with wavelengths needed for the photochemically induced degradation method. Therefore, the material of the enveloping tube is preferably made of quartz materials, preferably of synthetic quartz quality transparent for vacuum ultraviolet radiation below 200 nm.

In order to maintain good transmittance of the enveloping tube, means may be provided for cleaning the enveloping tube. Cleaning may be performed mechanically and/or chemically and the cleaning means may be operated manually or conveniently in an automatic manner.

The photochemical reactor unit may contain a plurality of radiation source modules which may be connected in series and/or in parallel depending on the design of the photochemical reactor unit and desirable flow conditions. Several photochemical reactor units may be connected in series and/or in parallel depending on the flux of the waste water to be treated, the nature and concentrations of the pollutants to be degraded. The radiation sources may be of different types having different emission spectra, or they can be all the same type having the same emission spectrum.

A preferred radiation source is a mercury low pressure lamp showing an emission spectrum with predominant emission lines at wavelengths of 185 nm and 254 nm. An enveloping tube of synthetic quartz allows transmission of both radiation at 185 nm and 254 nm whereas an enveloping tube of natural quartz allows only transmission of radiation at 254 nm.

Other suitable radiation sources are excimer lamps producing light of the wavelength range as claimed, particularly suitable sources are vacuum ultraviolet radiation sources, such as Xe excimer lamps with the emission maximum at 172 nm, an ArF and ArCl excimer lamp with the emission maximum at 193 nm and 175 nm, respectively. Other radiation sources capable of emitting radiation in said wavelength range comprise UV-C radiation sources, as the KrCl excimer lamp with an emission maximum at 222 nm, for example.

With regard to the broad variety of power, dimensions and geometries of radiation sources and lamps commercially available, the degradation and elimination of xenobiotics based on the irradiation technique of water with vacuum ultraviolet radiation at 185 nm, possibly in conjunction with ultraviolet-C radiation at 254 nm, may advantageously be implemented for all water treatment facility sizes.

A water level regulating system can be especially useful in a photochemical reactor unit 2 with the open channel design of FIG. 1.

The radiation source module is operated, as known by the person skilled in the art, when connected with the electrical power device comprising means for operating and controlling the radiation source or the radiation source module.

In order to assist oxidation methods and to achieve total mineralization of the xenobiotics, the purifying device is equipped with at least one device for supplying compressed air or dioxygen to the photochemical reactor unit, especially in the irradiated area surrounding the radiation source module. In situ production of dioxygen may be realized electrochemically using electrodes arranged in suitable manner in the irradiated area.

In order to manage large volume flows of waste water a plurality of membrane filtration units may be arranged in series and/or in parallel followed by a plurality of photochemical reactor units, whereby a main inlet for the large scale volume flow of waste water may connected with a flow splitter dividing the flow into several subflows feeding the membrane filtration units. Accordingly a permeate merging device may be designed.

Arrangement of at least one device for feeding hydrogen peroxide into the photochemical reactor unit serves for generating additional hydroxyl radicals by homolysis of hydrogen peroxide in a wavelength range above 190 nm, where photochemical homolysis of water doesn't occur. Consequently, the emitted radiation of the mercury low pressure lamp results in generating hydroxyl radicals due to homolysis of water at 185 nm and generating hydroxyl radicals by homolysis of hydrogen peroxide at 254 nm.

Hydroxyl radicals initiate different radical reactions with the xenobiotics which in combination with dioxygen lead to degradation and mineralization of the xenobiotics. Reaction pathways of those hydroxyl radical initiated reactions are known in the art.

The purifying method comprises the steps of passing a continuous flow of contaminated water through the membrane filtration unit for removing suspended and solvated macromolecular matter followed by the irradiation of the permeate (containing dissolved contaminants of relative low molecular weight) with ultraviolet radiation of the 100 to 280 nm wavelength range. Irradiation takes place in the photochemical reactor unit and produces hydroxyl radicals that initiate the elimination of xenobiotics.

The supply of compressed air or dioxygen to the photochemical step enhances degradation and mineralization of xenobiotics and therefore their elimination. After irradiation, the purified water (indicated by arrow C, see FIG. 2) can be discharged via one or more outlets 2″ from the photochemical reactor unit.

The purifying device and method are adapted for removing xenobiotcs and total organic carbon from any kind of contaminated water. The method may preferably be carried out continuously. It should, however, be noticed that the process may be carried out continuously or semi-continuously: For semi-continuous operation, the water is repeatedly subjected to irradiation.

The following examples illustrate the photochemical induced decomposition step of xenobiotics more clearly. The examples are given only for illustrating purposes and are not to be understood as to be limiting with respect to the scope of the present invention.

### Example 1

### Degradation of Dichlorvos (an Organophosphoric Insecticide) in a Purifying Device with a Mercury Low Pressure Lamp as Radiation Source Placed in a Synthetic Quartz Tube

Dichlorvos belongs to external insecticides which become effective for insects after contact, ingestion or inhalation, e.g.; it is used in households and agriculture. This molecule is rather stable in an aqueous environment of acid pH and its rate of hydrolysis increases with pH and temperature leading to the formation of dimethyl-phosphoric-acid and of dichloro-acetaldehyde.

Dichlorvos of an initial concentration of 10⁻³ mol/l in 350 ml of water is reduced to zero within 50 minutes, after exposition to vacuum ultraviolet radiation in combination with UV-C radiation (batch process, low pressure mercury lamp in synthetic quartz tube, 40 W).

### Example 2

### Degradation of 2,4-dihydroxy-benzoic acid in a Purifying Device with a Xe Excimer Lamp as Radiation Source

2,4-dihydroxy-benzoic acid is a decomposition product of salicylic acid frequently found in sewage water. Its presence accounts for toxic phenomena with increasing importance as concentration in water rises. With rising concentrations, decomposition of the compound becomes more difficult.

2,4-dihydroxy-benzoic acid of an initial concentration of 400 mg/l in 350 ml of water is reduced to zero within 70 minutes, after exposition to vacuum ultraviolet radiation (batch process, Xe excimer, photon flux: Pa=(5.0 35 0.5) 10′⁷ photon/s). If the concentration is 10 times lower, total degradation can be achieved in less than 10 minutes.

A mercury low pressure lamp enveloped by a synthetic quartz tube could be used as well, if desired, with addition of hydrogen peroxide.

### Example 3

### Degradation of 2,3,4-trihydroxybenzoic acid in a Purifying Device with a Xe Excimer Lamp

2,3,4-trihydroxybenzoic acid of an initial concentration of 400 mg/l in 350 ml of water is reduced to zero within 60 minutes, after exposition to vacuum ultraviolet radiation (batch process, Xe excimer, photon flux: Pa=(5.0 ±0.5) 10′⁷ photon/s). If the concentration is 10 times lower, total degradation can be achieved in less than 10 minutes.

Herein, too, a mercury low pressure lamp enveloped by a synthetic quartz tube could be used as well, if desired with addition of hydrogen peroxide.

### Example 4

### Degradation of Glycerol Trinitrate in a Purifying Device with a Xe Excimer Lamp

Glycerol trinitrate of an initial concentration of 1.2 g/l in 350 ml of water is eliminated with a rate of 4 mg/s under conditions of permanent saturation of the solution with air and after exposition to vacuum ultraviolet radiation (Xe excimer, 120 W). After mineralization of the pollutant has been completed, no traces of nitrite have been found in the solution.

With respect to total organic carbon (TOC), the results are excellent as well: Any type of contaminated water can be treated with the method and devices as described above, leading to a total elimination of TOC in the obtained purified water.

1-11. (canceled)

12. Method A method for eliminating xenobiotics in water using a purifying device, the method comprising the steps of:
providing a purifying device having a first photochemical reactor unit with an inlet for contaminated water and an outlet for purified water and a mercury low pressure lamp emitting radiation with two predominant emission lines at 185 nm and 254 nm into the water flow path, an upstream hydrophilic membrane filtration unit connected upstream of the inlet of the first photochemical reactor unit, a supply device supplying air or dioxygen to the water in the first photochemical reactor unit, and a liquid hydrogen peroxide supply device feeding to the photochemical reactor unit;
feeding a continuous flow of contaminated water into the membrane filtration unit;
performing ultra filtration, thereby removing suspended and solvated macromolecular matter from the water;
conducting the permeate via the at least one inlet into the photochemical reactor unit;
subjecting the water flowing from said inlet to said outlet to ultraviolet radiation at wavelengths ranging from 100 to 280 nm, thereby generating hydroxyl radicals initiating degradation of said xenobiotics; and
supplying air or dioxygen into the water, thereby enhancing the initiated oxidative degradation of said xenobiotics.

13. The method according to claim 12, wherein the method is a two step procedure.

14. The method according to claim 12, comprising the step of feeding hydrogen peroxide into the permeate upstream the inlet of or within the photochemical reactor unit.

15. The method according to claim 12, wherein the method is carried out continuously or semi-continuously, with the semi-continuously performed method requiring a continuous flow of water to be repeatedly subjected to ultraviolet radiation by recirculating it through or more photochemical reactor units.

16. The method according to claim 12, wherein the method is adapted to remove total organic carbon (TOC) from water.

17. The method according to claim 13, wherein the method is adapted to remove total organic carbon (TOC) from water.

18. The method according to claim 14, wherein the method is adapted to remove total organic carbon (TOC) from water.

19. The method according to claim 15, wherein the method is adapted to remove total organic carbon (TOC) from water.
